(19) United States
(12) Patent Application Publication
(10) Pub. No.: US 2025/0379750 A1
(43) Pub. Date: Dec. 11, 2025

(54) SYSTEMS AND METHODS FOR ADAPTIVE ENCRYPTION FOR INTEROPERABILITY OF MESSAGING APPLICATIONS

(71) Applicant: ZixCorp Systems, Inc., Dallas, TX (US)

(72) Inventor: Mark Albert Mackenzie, McKinney, TX (US)

(21) Appl. No.: 19/220,728

(22) Filed: May 28, 2025

Related U.S. Application Data
(60) Provisional application No. 63/658,536, filed on Jun. 11, 2024.

(51) Int. Cl. H04L 9/32; H04L 9/06; H04L 9/08

(52) U.S. Cl. CPC H04L 9/3268; H04L 9/0631; H04L 9/088

(57) ABSTRACT

Embodiments herein relate to systems and methods for secure messaging interoperability between email gateways with different capabilities. A capability indicator within the recipient's public certificate addresses potential incompatibility between email gateways. A sending gateway obtains the recipient's certificate and checks the certificate for the indicator. Based on the check, the sender adaptively selects either an enhanced or a legacy encryption scheme. The message is then encrypted using the selected scheme and transmitted.

### CROSS-REFERENCE TO RELATED APPLICATIONS

This application claims a benefit of priority under 35 U.S.C. § 119 (e) to U.S. Provisional Application Ser. No. 63/658,536, filed Jun. 11, 2024, entitled “SYSTEMS AND METHODS FOR ADAPTIVE ENCRYPTION FOR INTEROPERABILITY BETWEEN MESSAGING APPLICATIONS,” which is hereby incorporated herein for all purposes.

### TECHNICAL FIELD

This disclosure relates generally to electronic messaging. In particular, this disclosure relates to adaptive encryption of electronic messaging for enhancing interoperability between messaging systems.

### BACKGROUND

Secure electronic messaging is critical for network communications infrastructure. Security protocols provide cryptographic security for email messages in transit. Security gateway appliances using a public key infrastructure (PKI) often mediate the protocols themselves using digital certificates. The certificates act to securely bind a cryptographic public key to an entity such as a gateway or a user.

As security requirements and cryptographic techniques evolve, encryption protocols such as Secure/Multipurpose Internet Mail Extensions (S/MIME) are revised to enhance security. The revisions introduce different protocol versions (e.g., S/MIME v3, S/MIME v4). These newer versions often incorporate stronger encryption algorithms or other benefits. However, not all organizations or users adopt new software versions simultaneously. This staggered deployment of the protocol versions results in a mixed network environment. In this mixed network environment, systems supporting the newest protocol versions are required to interact with legacy systems that support older protocol versions.

A significant challenge arises when a sending system (with the latest protocol version) intends to transmit a message to a recipient system having capabilities unknown to the sending system. If the recipient system does not support the protocol used by the sending system, the sending of a message formatted according to the newer version can lead to decryption failures and communication breakdown between the sender and the recipient. Furthermore, protocols like S/MIME are often stateless, meaning that the sending system and the receiving system cannot negotiate a compatible protocol before data transmission begins. Attempting to manage compatibility between systems through out-of-band communication or manual configuration is generally not feasible in large-scale deployments.

Without certainty about the receiving system's capabilities, the sending system may revert to a less-secure version of encryption to ensure communication continuity. Sending messages or other data with the sender's current encryption protocol risks communication failure with an unverified system.

### SUMMARY OF THE DISCLOSURE

Encryption algorithms that are desirable to use with an email application may be constantly evolving. As discussed above, however, email applications are deployed asynchronously to these standards or recommendations. Accordingly, email applications deployed at different times may have different capabilities: email applications deployed prior to a certain time may be adapted to use legacy encryption algorithms while email applications deployed subsequently may be adapted to utilize other (e.g., more current) encryption algorithms. It is desirable, however, that regardless of their time of deployment, such email applications be interoperable. Commensurate with this desire, however, is the desire that certain encryption algorithms be utilized (e.g., a most current encryption algorithm with the understanding that for purposes of this disclosures most current will be understood to not necessarily refer to time, but instead to any desired encryption algorithm it is desired to use, such as the most recently mandated or recommended, the most secure available encryption algorithm, etc.).

To address these conflicting desires, among others, embodiments as disclosed herein may allow a sending messaging application to ascertain the encryption capabilities of a receiving application through the use of a certificate associated with the receiving messaging application. Specifically, many messaging applications rely on asymmetric encryption using a public/private key pair. In such cases, a certificate may be used to obtain the public key of a recipient application. These certificates bind the public key to an identity (e.g., a person, organization, particular server or application, etc.). These certificates can be obtained from a (e.g., centralized) certificate repository responsible for maintaining such certificates. One example of such a certificate repository may be, for example, a certificate authority which may also digitally sign certificates for which it is responsible. For example, X.509 is a standard format for public key certificates. An X.509 certificate contains information such as a recipient entity's identity (e.g., name), the public key, an expiration date, a digital signature of a certificate authority, etc. As another example, in certain email ecosystems comprising a number of deployed instances of a messaging application a provider or maintainer of the email ecosystem may maintain a certificate repository for certificates associated with those deployed messaging applications.

What is desired, therefore, is a mechanism to allow a sending messaging application to automatically determine encryption capabilities of recipient systems such that the sending messaging application can encrypt messages according to the capabilities of individual recipient systems. In this manner, a desired encryption algorithm can be utilized when it is supported by a recipient system, while an encryption algorithm supported by the recipient may still be utilized in cases where the desired encryption algorithm is not supported.

To illustrate in more detail, encryption may be desired in the sending of email messages, accordingly certain standards have been promulgated to facilitate encryption in an email context. As an example, the Internet Engineering Task Force (IETF) is a body responsible for developing and maintaining many Internet standards, including S/MIME, a widely used protocol for securing email messages through encryption. S/MIME builds upon the MIME (Multipurpose Internet Mail Extensions) standard, which defines the standard for emails to include various types of content such as text, images, and attachments.

The evolution of encryption techniques utilized in association with S/MIME has been a critical aspect of its development and adoption, including maintaining the security of emails transmitted according to this standard. For example, the National Institute of Standards and Technology (NIST) provides recommendations for cryptographic algorithms through its Special Publication 800-175B, which covers the use of the S/MIME protocol, hereby incorporated herein by reference in its entirety. The NIST and IETF periodically update their recommendations and standards based on advancements in cryptography and emerging security considerations.

For example, NIST stated that the use of the PKCS #1 v1.5 padding scheme should not be used after Dec. 31, 2023, in Special Publication 800-131A “Transitioning the Use of Cryptographic Algorithms and Key Lengths” hereby incorporated by reference in its entirety. The IETF added (RSA with Optimal Asymmetric Encryption Padding (OAEP) as a supported algorithm in Request for Comment (RFC) 5751 “S/MIME Version 3.2 Message Specification” while RFC 8551 “S/MIME Version 4.0 Message Specification” supports the use of the AES 256 Galois/Counter Mode (GCM) cipher for mitigation of certain vulnerabilities. All publications (e.g., including RFCs) listed herein are incorporated herein by reference in their entirety.

Embodiments as disclosed herein may include encryption capability data in a certificate associated with a messaging application (e.g., a certificate including the public key of that messaging application). This encryption capability data may specify the encryption capability of the messaging application (e.g., system, server, etc.) identified by the certificate and associated with the public key specified by the certificate. This encryption capability may specify one or more encryption algorithms, or associated configurations of those encryption algorithms, that the messaging application corresponding to the certificate is adapted to utilize. In particular, embodiments may include this encryption capability data in an attribute of a certificate associated with a messaging application, where this encryption capability data may be included in an attribute that is defined by a standard (e.g., the X.509 standard) or may add an attribute (e.g., not defined or specified by a standard) to other attributes (e.g., defined by a standard) of a certificate. As but one example, embodiments may include such encryption capability data in an X.509 (Extended) Key Usage extension attribute.

According to some embodiments, when an email messaging application is installed or added to an email messaging environment, the newly installed email messaging application may generate a public/private key pair for that email application. The email messaging application can then generate a certificate identifying the email application and including the generated public key, such as an X.509 certificate or the like. The email messaging application can also include encryption capability data for the email messaging application in the generated certificate.

As can be seen, secure messaging systems using stateless encryption protocols (such as S/MIME) face significant challenges in a mixed-version encryption environment. By not having a mechanism to negotiate compatible encryption before data transmission, communication failures and decryption errors may occur. Reverting to older, more universal encryption protocols results in less-secure communication between messaging systems.

It is desired for a messaging application or system to convey its encryption and decryption capabilities to another messaging application (e.g. recipient). This allows the most secure encryption protocol to be selectively employed for communication between mutually compatible systems. The risk of using an incompatible encryption protocol is prevented, because the capabilities of a recipient system are known before encrypted data transmission begins. Thus, the strongest available security is implemented during data transmission.

By evaluating a public certificate (of a recipient) and determining that the recipient's public certificate contains a predefined capability indicator, the sending system selects an enhanced encryption scheme whenever possible and without introducing a disruption to a legacy system. The predefined compatibility indicator signifies support for the enhanced encryption scheme at the recipient messaging gateway. When the predefined compatibility indicator is not present (e.g. absent) in the recipient's public certificate, the sender selects a legacy encryption protocol to ensure communication compatibility with the recipient. The addition of the predefined compatibility indicator in a specific location (e.g. attribute of an extensions section) of the public certificate provides notice to a sender regarding the recipient's enhanced protocol compatibility. Moreover, the attribute is included in a section or extension of the public certificate that does not disrupt legacy systems upon receiving the certificate. As such, communication protocols are selected while preserving compatibility with the existing installed base of email systems.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a block diagram of a networked computing environment including email messaging applications for adaptive encryption of messages according to embodiments.

FIG. 2 is a sequence diagram depicting a method of adaptive encryption of email messages according to an embodiment.

FIG. 3 is a block diagram of an enhanced system architecture for adaptive encryption according to embodiments.

FIG. 4A is a conceptual diagram of a Key Usage extension capability indicator according to an embodiment.

FIG. 4B is a conceptual diagram of a custom extension capability indicator according to an embodiment.

FIG. 4C is a conceptual diagram of a Certificate Policies extension capability indicator according to an embodiment.

FIG. 5 is a flowchart depicting a certificate generation method including a capability indicator according to an embodiment.

### DETAILED DESCRIPTION

Before describing embodiments herein in more detail, should be understood that while certain embodiments are described herein in association with email messaging applications, and in particular email messaging applications that utilize S/MIME and certain public/private key based encryptions algorithms that are currently recommended by specific standard setting bodies, embodiment as described herein are more generally applicable to any type of messaging application that employ public/private key cryptography utilizing certificates that may employ multiple encryption algorithms. Thus, the description of embodiments in association with email, S/MIME and particular encryption algorithms should not be taken in any way as limitations on embodiments generally.

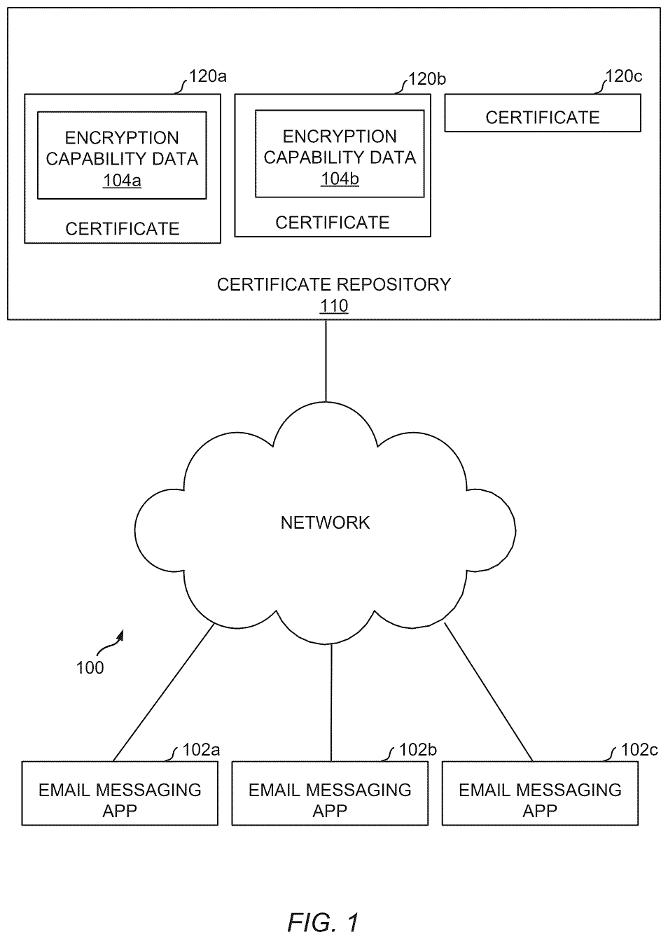

Turning to FIG. 1, a network environment 100 including email messaging applications 102 that are adapted to perform adaptive encryption (according to an embodiment) is depicted. Network environment 100 also includes a certificate repository 110 (e.g., which may be maintained by a certificate authority, a provider of email messaging applications 102, or another entity). An email messaging application 102 may generate a public/private key pair and generate a corresponding certificate 120 that may be stored in certificate repository 110. Certain of these email messaging applications 102 (e.g., email messaging application 102c) may have been deployed before a certain time point or may not have certain capabilities. Thus, these email messaging applications 102 (e.g., 102c) may generate a certificate 120 (e.g., 120c) that does not include any encryption capability data (e.g., these types of email messaging applications 102c may be an installed base).

Other of these email messaging applications 102 (e.g., email messaging applications 102b) may include adaptive encryption capabilities or otherwise be deployed after a certain time, and be adapted to include encryption capability data 104 in their certificates 120 (e.g., encryption capability data 104b in certificate 120b). Accordingly, when these email messaging applications 102 generate a certificate 120 including a public key for that email messaging application 102 (e.g., email messaging application 102b) the corresponding certificate 120 (e.g., certificate 120b) may include encryption capability data 104 (e.g., encryption capability data 104b) reflecting the encryption capabilities of that email messaging application 102 (e.g., email messaging application 102b). In certain cases, this encryption capability data may include a capability or encryption algorithm that the email messaging application (e.g., email messaging application 102b) is adapted to use when sending or receiving S/MIME email messages.

Accordingly, when an email messaging application 102 adapted for adaptive encryption wishes to send an encrypted email message (e.g., using the S/MIME protocol), sending email messaging application 102 (e.g., email messaging application 102a) can obtain the certificate 120 associated with the receiving email messaging application (e.g., email messaging application 102b or 102c) and evaluate the obtained certificate 120. Based on the presence or absence of encryption capability data 104 in the obtained certificate 120 (or the encryption capability data 104 itself), the sending email messaging application 102 (e.g., email messaging application 102a) can determine an encryption algorithm to use to encrypt the email message, encrypt the email message according to the determined encryption algorithm, and send the encrypted email message to the receiving email messaging application 102.

For example, email messaging application 102a may send an encrypted email message (e.g., using the S/MIME protocol) to email messaging application 102c. Here, sending email application 102a may obtain corresponding certificate 120c for receiving email messaging application 102c from certificate repository 110. Sending email messaging application 102a can then determine that the obtained certificate 120c corresponding to receiving email messaging application 102c does not include any encryption capability data. Accordingly, a default encryption algorithm may be determined by sending email messaging application 102a. In some embodiments, the default encryption algorithm is an encryption algorithm that is standard and supported by any version of that secure messaging protocol. Specifically, in some embodiments, a default encryption algorithm for S/MIME may be AES-256 using Cipher Block Chaining (CBC) and PKCS #1 v1.5 padding. The sending email messaging application 102a can then encrypt the email to be sent according to the default encryption algorithm, by using the public key specified in the obtained certificate 120c. The encrypted message is then sent to the receiving email messaging application 102c.

Additionally, email messaging application 102a may send an encrypted email message (e.g., using the S/MIME protocol) to email messaging application 102b. Sending email application 102a may obtain a corresponding certificate 120b pertaining to receiving email messaging application 102b from certificate repository 110. Sending email application 102a can determine that the obtained certificate 120b corresponding to receiving email messaging application 102b includes encryption capability data 104b. Sending email messaging application 102a can then evaluate encryption capability data 104b in certificate 120b to determine an encryption algorithm that is compatible with receiving email messaging application 102b.

In some embodiments, an encryption algorithm specified in the encryption capability data 104b of certificate 120b may be determined by the sending email application 102a. In some embodiments, an encryption algorithm associated with a supported version of a secure email sending protocol specified in encryption capability data 104b may be determined by sending email application 102a. As a specific example, the encryption capability data 104b may indicate that the receiving email messaging application 102b supports enhanced encryption protocol (e.g. S/MIME v4). Accordingly, sending email messaging application 102a sends messages to receiving email messaging application 102b using the enhanced encryption protocol. In some embodiments, the enhanced determining protocol is AES 256 using GCM with OAEP. The sending email messaging application 102a then encrypts the email to be sent according to the enhanced encryption algorithm using the public key specified in the obtained certificate 120b. One or more encrypted messages are sent to the receiving email messaging application 102b.

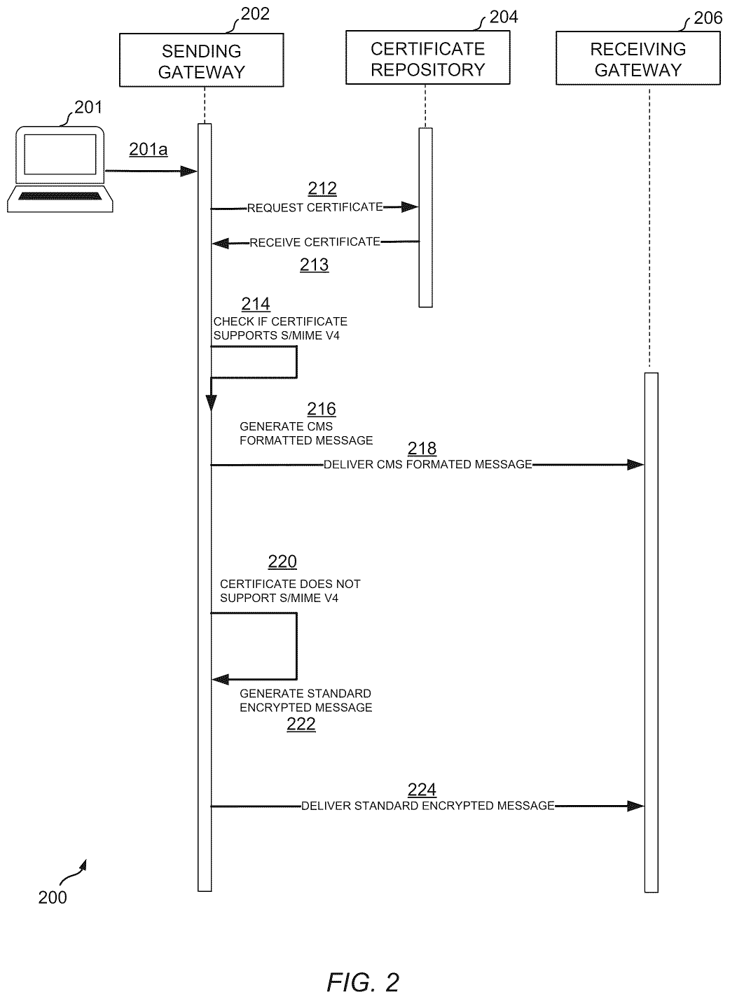

FIG. 2 is a sequence diagram illustrating a method 200 for adaptively selecting and applying an encryption scheme for a message, in accordance with embodiments of the disclosure. The diagram depicts interactions between a Sending Gateway 202, a Certificate Repository 204, and a Receiving Gateway 206.

In operation, the method 200 may begin when the Sending Gateway 202 receives or processes an outgoing message intended for a recipient associated with the Receiving Gateway 206. An external user or application 201 sending a message at step 201a initiates the outgoing message.

At step 212, the Sending Gateway 202, upon determining the message requires encryption for the recipient, requests a public certificate (e.g. X.509 certificate) from the Certificate Repository 204. The public certificate is associated with the Receiving Gateway 206. The Certificate Repository 204 may reside on the Sending Gateway 202 as a local cache, and thus the request may be internal to the Sending Gateway itself. In other embodiments, the Certificate Repository 204 is one of a plurality of repositories that store public certificates for gateways.

At step 213, the public certificate is obtained by the Sending Gateway 202 from the Certificate Repository.

At step 214, after obtaining the recipient gateway's certificate, the Sending Gateway 202 performs a check or determination based on the contents of the certificate to ascertain the capabilities of the Receiving Gateway 206.

Specifically, as shown at block 214, the Sending Gateway 202 determines if the retrieved certificate indicates support for an enhanced encryption protocol, (e.g. S/MIME version 4). This determination may involve examining specific properties, attributes, or extensions within the certificate, such as a Key Usage Extension bit, a custom attribute OID, or a Certificate Policy identifier, any of which serve as a predefined capability indicator.

If the determination 214 indicates that the Receiving Gateway 206 does support the enhanced encryption protocol (i.e., the capability indicator is present), the message is encrypted in accordance with the enhanced security protocol. The Sending Gateway 202 selects and applies an enhanced encryption scheme. As shown at Step 216, the implementation of this scheme may involve encrypting the message using algorithms associated with the enhanced protocol, such as AES-256-GCM encryption, and RSA with OAEP padding for key encryption/wrapping. The resulting cryptographic message syntax (CMS) formatted encrypted message is then delivered to the Receiving Gateway 206 as shown at step 218.

Alternatively, when the Sending Gateway 202 determines that the Receiving Gateway 206 does not support the enhanced security protocol (e.g., the capability indicator is absent, a determination cannot be made for the enhanced security protocol) as shown at step 220, the method follows to generate an encrypted message at Step 222. However, the encrypted message generated by the Sending Gateway 202 is generated from a default legacy encryption scheme known to be compatible with most systems. As shown, this may involve encrypting the message using algorithms associated with the legacy protocol, such as AES-256-CBC for symmetric encryption, and RSA with PKCS #1 v1.5 padding. The resulting legacy encrypted message is then delivered as shown at step 224 to the Receiving Gateway 206.

The method 200 allows the Sending Gateway 202 to automatically adapt the encryption method based on the determined capabilities of the Receiving Gateway 206. Method 200 leverages stronger security when available, while maintaining backward compatibility with legacy systems.

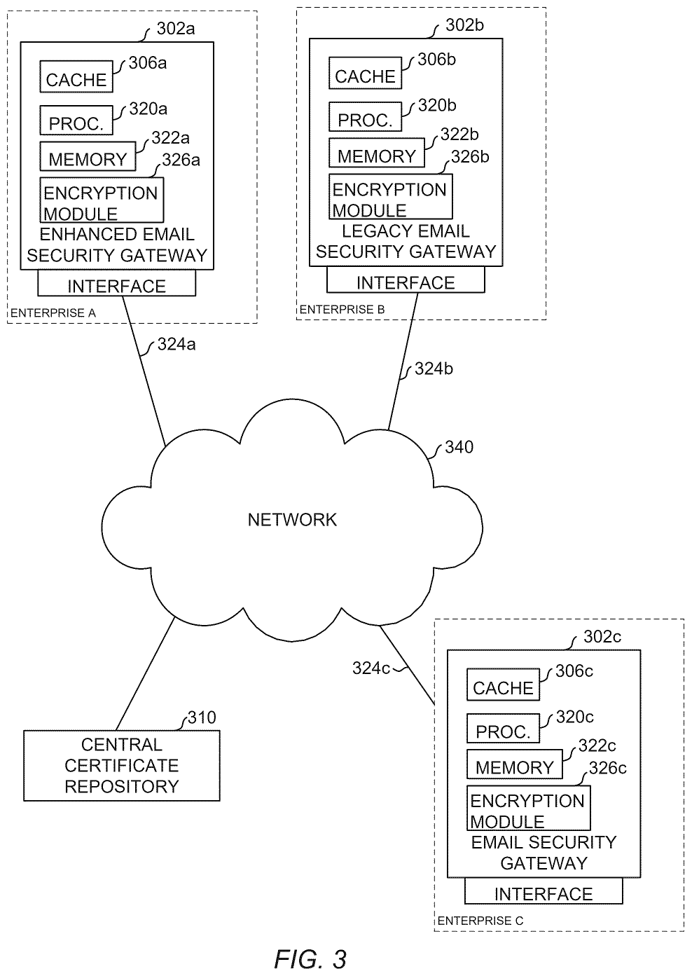

FIG. 3 provides a more detailed block diagram illustrating an example system architecture 300 within which embodiments of the adaptive encryption method may operate. FIG. 3 expands upon the overview shown in FIG. 1. The architecture 300 facilitates the management and distribution of cryptographic certificate information used for selecting appropriate encryption schemes.

The system 300 includes a plurality of email security gateways, such as gateway 302a, gateway 302b, and gateway 302c, any or all of which may be deployed at various locations. For example, the email security gateways may be deployed within different enterprise networks (e.g., Enterprise A, Enterprise B). These gateways are responsible for processing and securing email messages exchanged between users or systems.

Critically, the plurality of email security gateways 302 may represent different versions of gateway software, where the email security gateways possess different capabilities. For instance, gateway 302a may be an Enhanced Capability Gateway running updated software (e.g., version 8.0 or later) and capable of supporting enhanced encryption protocols (e.g., S/MIME v4). In contrast, gateway 302b may be a Legacy Gateway running older software (e.g., version 6.x or lower) and limited to supporting only older, legacy encryption protocols (e.g., S/MIME v2, S/MIME v3). Other gateways, like 302c, could be of either type depending on their deployment status.

The system 300 further includes a Central Certificate Repository 310. Central Certificate Repository 310 may be hosted and managed by a central entity or service provider (e.g., Zix/OpenText) and serves as a master database storing the public X.509 certificates associated with the participating gateways 302a, 302b, 302c within the ecosystem.

Each gateway 302a, 302b, 302c maintains a local certificate cache or repository (e.g., local cache 306a associated with gateway 302a, 306b with 302b, etc.). The gateways periodically communicate with the Central Certificate Repository 310 via synchronization links 330a, 330b, 330c over a network 340. In some embodiments, network 340 is the Internet. During synchronization, gateways download updated certificate information from the Central Certificate Repository 310 to refresh their respective local caches 306a, 306b, 306c. This ensures each gateway 302 has reasonably up-to-date public certificates for other participating gateways, which are used in the adaptive encryption method described above.

As shown within gateway 302a, each gateway typically includes processing hardware and software components necessary for its operation. These may include one or more processors 320 configured to execute instructions, memory 322 storing executable instructions (e.g., for implementing the adaptive encryption method), data (including the local certificate cache 306a), and one or more network interfaces 324 for communicating over the network 340 (both for email transmission and certificate synchronization). An encryption module 326, which may be implemented in hardware or software executed by processor 320, performs the actual cryptographic operations (encryption/decryption) using the algorithms selected by the adaptive method.

Gateways 302a, 302b, and 302c communicate with one another over the network 340. A primary function of this communication is the exchange of email messages between their respective users or systems. These email messages may require encryption for security. When encryption is applied, the gateways utilize the adaptive encryption methods described herein, such as method 200 illustrated in FIG. 2.

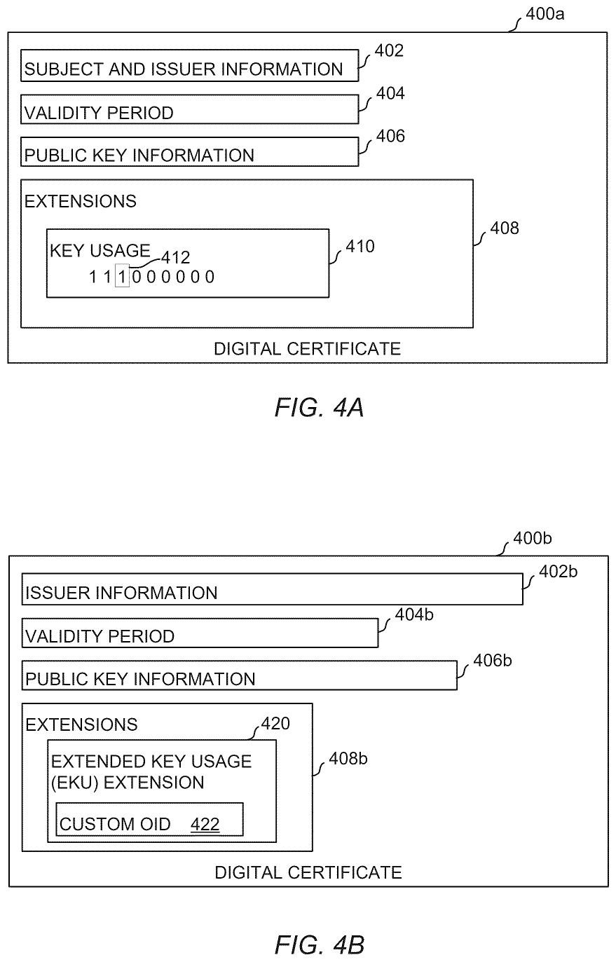

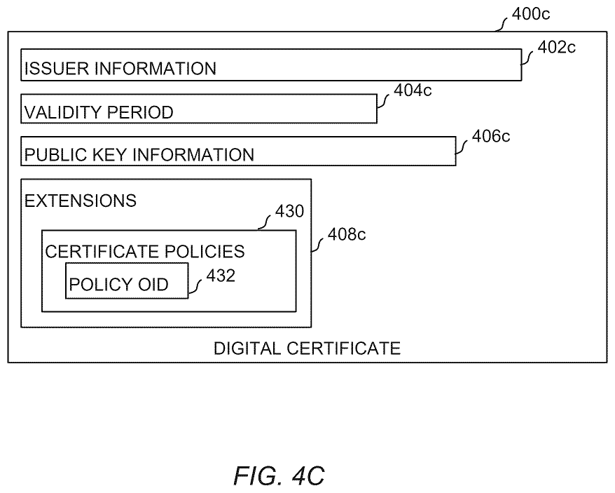

The system architecture is designed to support this adaptive encryption even when gateways possess different capabilities. For instance, gateway 302a represents an Enhanced Capability Gateway supporting enhanced protocols (e.g., S/MIME v4), while gateway 302b represents a Legacy Gateway supporting only older protocols. The architecture ensures seamless operation in such mixed, heterogeneous environments. Public certificates, which include indicators reflecting these differing capabilities (as detailed in FIG. 4), are managed centrally in the Central Certificate Repository 310. A synchronization mechanism, via links 330, distributes these certificates to the local caches (e.g., 306a, 306b) of all participating gateways. This distribution ensures that when one gateway (e.g., 302a) prepares to send an encrypted message, it can access the recipient gateway's (e.g., 302b or 302c) certificate information from local cache 306a. Access to this certificate information allows the sending gateway to determine the recipient's capabilities. Based on these capabilities, the sending gateway makes the appropriate encryption choice to ensure communication compatibility. The sending gateway selects either the enhanced or the legacy encryption protocol as dictated by method 200.

FIGS. 4A, 4B and 4C provide conceptual illustrations of example embodiments showing how a capability indicator may be encoded within the structure of a public certificate 400a (e.g. X.509 digital certificate). In some embodiments, the compatibility indicator signifies support for an enhanced encryption scheme (e.g., S/MIME v4) in certificate 400. In some embodiments, as shown in FIG. 4A, Certificate 400a comprises the following fields: Subject and Issuer Information 402, Validity Period 404, Public Key Information 406, and an Extensions section 408. The listing of fields is not necessarily including all or not limited to those listed herein. As such, the Extensions section 408 allows for the inclusion of additional standardized or custom information. The capability indicator used by the sending gateway (e.g., 202 in FIG. 2) to perform the check may be implemented within this structure in various implementations, including but not limited to the capability indicator described herein in FIGS. 4A, 4B and 4C.

In an embodiment, illustrated as FIG. 4A, the capability indicator is derived from the standard Key Usage extension 410. The Key Usage extension 410 comprises a bit string, where specific bits correspond to permitted cryptographic operations. A designated bit 412 within this extension may be used as the indicator. The designated bit 412 is relevant to S/MIME encryption functions (e.g., keyEncipherment or dataEncipherment) in some embodiments. The bit corresponding to keyEncipherment is shown for illustrative purposes only. For instance, newer gateway software may be configured to set designated bit 412 during certificate generation. Legacy gateway software does not set the bit corresponding to designated bit 412. Thus, the presence (e.g. set state, a value of “1”) of bit 412 indicates support for the enhanced encryption scheme by the gateway associated with the certificate. The absence of a designated bit, such as an unset designated bit, (e.g. unset state, a value of “0”) indicates legacy status for the gateway of the certificate.

In another embodiment, as illustrated in FIG. 4B, a capability indicator is implemented as a custom extension of Extended Key Usage (EKU) extension 420 within the Extensions section 408b of certificate 400b (e.g. X.509 digital certificate). Similar to the certificate of FIG. 4A, Certificate 400b comprises Subject and Issuer Information 402b, Validity Period 404b, Public Key Information 406b, and Extensions section 408b. EKU extension 420 contains one or more unique, predefined Object Identifiers (OIDs), one of which is predefined custom extension Object Identifier 422 (e.g., an OID assigned specifically for this purpose within the Zix ecosystem). The presence of this specific custom extension OID 422 within the certificate 400 indicates that the gateway associated with the certificate does in fact support an enhanced encryption scheme. Systems not configured to recognize this specific custom extension OID 422 ignore the custom extension. The ignoring of the custom extension OID 422 by a legacy system results in the systems retaining continuity of communication during and following certificate exchange.

In another embodiment, illustrated in FIG. 4C, the capability indicator is implemented using a Certificate Policies extension 430 within the Extensions section 408c of certificate 400c (e.g. X.509 digital certificate). Similar to the certificate of FIG. 4A, Certificate 400c comprises Subject and Issuer Information 402c, Validity Period 404c, Public Key Information 406c, and Extensions section 408c. The Certificate Policies extension 430 is a standard extension defined to contain a sequence of one or more certificate policy identifiers. In some embodiments, the certificate policy identifiers are Object Identifiers (OIDs). Each OID refers to a specific certificate policy, which is a named set of rules indicating the certificate applies to a class of applications. In some embodiments, these OIDs indicate policies under which the certificate was issued or should be handled. In this embodiment, a specific and unique policy OID 432 is predefined within the messaging ecosystem (e.g., by the system provider) to explicitly signify that the certificate holder (i.e., the recipient gateway) supports the designated enhanced encryption scheme (e.g., S/MIME v4). In another embodiment, the specific and unique policy OID 432 is accompanied by a policy qualifier that states a human-readable command (e.g. “Strong Encryption Enabled”). The human readable command serves in an embodiment as the capability indicator.

When a sending gateway implementing this embodiment performs the capability check (e.g., Decision 214 of FIG. 2), it inspects the sequence of policy OIDs present within the recipient certificate's Certificate Policies extension 430. The sending gateway specifically searches this sequence for the presence of the unique policy OID 432. If this unique policy OID 432 is found within the extension, its presence serves as the positive capability indicator, signaling that the enhanced encryption scheme should be used. Alternatively, the presence of a specific human readable command in the policy qualifier may also be evaluated to determine a positive capability indicator. Any other policy OIDs that might also be present within the same Certificate Policies extension 430 may be disregarded by the sending gateway for the purpose of this specific capability determination. Thus, the detection of the designated policy OID 432 reliably indicates the recipient's enhanced encryption capabilities.

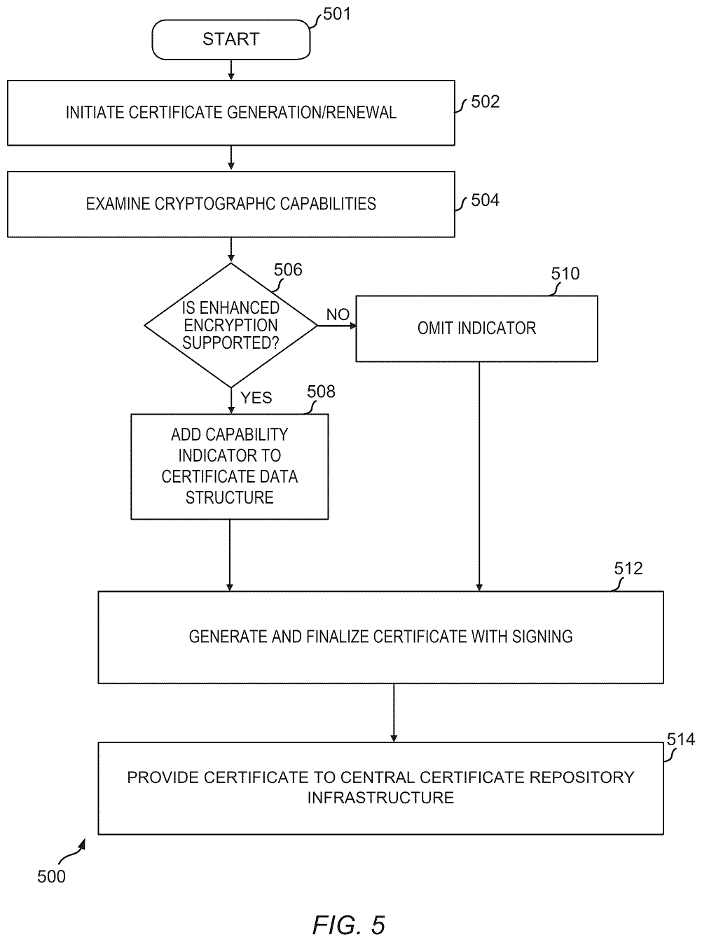

FIG. 5 is a flowchart illustrating a method 500 for generating a certificate that incorporates a capability indicator, according to embodiments of the disclosure. Certificates generated by method 500 reflect whether the email gateway associated with the certificate supports an enhanced encryption scheme (e.g., S/MIME v4).

Method 500 begins at Start 501 and continues at Step 502 with the initiation of certificate generation or renewal for an email gateway. This initiation may be triggered by one or more events or conditions, such as, but not limited to: an administrator action via a management interface, the scheduled expiration of an existing certificate, or a requirement for a new certificate following a gateway software upgrade.

Following initiation, the gateway software performs a self-analysis to determine its own cryptographic capabilities, as set forth at Step 504. This involves the gateway evaluating its internal state against criteria for supporting what has been predefined as the enhanced encryption protocol. This “enhanced protocol” refers to a specific target set of capabilities, such as those required for S/MIME version 4, including support for particular algorithms (e.g., AES-GCM, RSA-OAEP) and message formats (e.g., CMS). The definition of which features constitute this “enhanced protocol” is embedded within the gateway's software programming and/or configuration data. Therefore, the determination at Decision Step 506 involves the gateway checking its own current software version number (e.g., comparing it to a threshold version like v8.0 known to include enhanced support) and/or checking relevant internal configuration settings against these predefined criteria. Based on this internal comparison, the gateway determines whether it possesses the necessary capabilities to support the predefined enhanced encryption protocol.

If the gateway determines that it does support the enhanced encryption protocol, as shown in the “Yes” path from Decision 506), the predefined capability indicator within the certificate data structure is added to the certificate, as set forth at Step 508. Referring back to FIGS. 4A-4C, the adding of the predefined capability indicator involves setting a specific bit in the Key Usage extension (e.g., 412) or utilizing another agreed-upon mechanism within the certificate structure.

If the gateway determines that it does not support the enhanced protocol, as indicated by a “No” path from Decision 506), the method proceeds to step 510. At step 510, the capability indicator is intentionally omitted from the certificate data or certificate signing request (CSR). This ensures that certificates generated by legacy gateways do not include an attribute that would signal support for enhanced encryption protocols.

Following the capability check, the method proceeds to generate and finalize the certificate (Step 512). This generation may involve the gateway self-signing the X.509 certificate or generating a CSR that is sent to a Certificate Authority (CA) for signing, with the resulting signed certificate being returned to the gateway. If the indicator was added as detailed in Step 508, the finalized certificate contains this indicator.

The newly generated certificate (either containing or lacking the indicator based on the determination at Decision 506) is provided to the central certificate management infrastructure at Step 514. This typically involves the gateway uploading the certificate to a repository such as the Central Certificate Repository 310 of FIG. 3. Once the certificate is uploaded, it is available for synchronization and retrieval by other gateways in the ecosystem. This generation process ensures that the presence or absence of the capability indicator on distributed certificates accurately reflects the capabilities of the associated gateways, enabling an adaptive encryption method.

According to some embodiments, an example of an X509 certificate that includes a keyword of “E-mail Protection” in the X509 Extended Key Usage extension attribute is presented in the following Appendix (Appendix A). The inclusion of the keyword “E-mail Protection” in this attribute may indicate that the email messaging application associated with that certificate supports a current version of S/MIME (e.g., version 4) and that a particular (e.g., most current) encryption algorithm such as AES 256 using GCM with OAEP, should be utilized.

```
APPENDIX A
Certificate:
  Data:
    Version: 3 (0x2)
    Serial Number: 1716297473438 (0x18f9b4d1d9e)
    Signature Algorithm: sha1WithRSAEncryption
    Issuer: DC = com, DC = example, DC = zgw, DC = zixvpm, OU = zgw, O =
        ZixCorp, CN = ZixVPM/664C9F01
    Validity
        Not Before: May 21 13:17:53 2023 GMT
        Not After : May 21 13:17:53 2034 GMT
    Subject: DC = com, DC = example, DC = zixvpm, OU = zgw, O = ZixCorp,
        CN = ZixVPM/664C9F01
    Subject Public Key Info:
        Public Key Algorithm: rsaEncryption
          RSA Public-Key: (3072 bit)
          Modulus:
            00:ac:d7:cb:15:80:80:41:bb:7a:b5:af:bc:16:ef:
            8b:04:03:9a:a9:8c:ff:6d:d2:63:4b:56:bb:b6:87:
            63:c7:cd:38:76:14:b9:e5:0b:7e:22:c5:72:2b:55:
            5e:2f:61:7a:c5:2b:19:b2:03:c1:17:4d:c9:e9:db:
            b3:6a:d8:ae:34:e7:48:d5:22:28:00:e5:01:03:0f:
            f3:a8:9c:32:ea:47:38:ea:45:ff:fe:85:a3:6f:1c:
            c0:03:1f:10:1b:f4:c8:80:bb:1d:7e:0e:90:de:01:
            d1:79:f7:22:03:82:ca:1d:e8:9f:d4:24:e8:78:44:
            0b:4f:9d:27:32:b7:ea:36:3d:60:c4:5c:31:37:fc:
            06:99:d4:b0:3a:dd:f9:09:50:2e:2e:73:ac:17:d9:
            9e:c7:af:17:35:01:8e:03:0f:86:fb:49:85:e3:e0:
            25:e3:4a:be:47:ba:48:7d:08:02:a1:37:95:0f:e9:
            89:72:6d:ab:85:aa:84:b3:7a:7a:a6:c8:69:21:d4:
            2e:07:e1:00:35:b3:0e:b3:fb:07:2f:ca:84:56:50:
            0f:ac:4d:0e:26:3d:ad:89:8c:a3:d4:72:08:1a:df:
            90:e4:77:72:05:be:4d:c9:ef:0d:35:7b:66:e2:cc:
            0c:48:60:bb:b6:19:ef:4c:10:f3:d2:c3:75:65:66:
            b7:b6:3f:26:d6:3d:0e:af:69:35:e0:9b:63:c4:e5:
            ca:16:6e:7d:85:46:e3:c7:1a:83:ee:a4:91:a5:5b:
            d2:6b:61:f6:5a:64:b0:58:9c:cd:f5:0d:96:46:0d:
            41:6a:91:3d:74:4d:0f:0e:f2:49:1f:5d:51:61:13:
            e1:f2:84:44:3f:62:20:b5:31:04:19:3f:38:1d:bc:
            fa:ad:26:40:1f:8e:4a:2a:ef:12:a0:b1:5e:95:72:
            2f:89:81:d1:ff:2f:5a:df:05:73:6a:a1:7b:ba:da:
            2e:53:4e:ac:a9:72:97:9b:da:2d:d2:ae:a2:41:43:
            e9:38:81:22:4b:1b:60:35:1d:5d
          Exponent: 65537 (0x10001)
    X509v3 extensions:
        X509v3 Subject Alternative Name:
          email:zixvpmgateway@zixvpm.zgw.example.com
        X509v3 Extended Key Usage:
          E-mail Protection
  Signature Algorithm: sha1WithRSAEncryption
      99:aa:14:7d:e1:04:91:ff:90:83:bf:33:1e:4e:48:5a:d2:b4:
      0f:92:7a:a7:eb:22:74:57:ee:64:1c:61:bb:5f:0e:d9:55:77:
      83:39:ed:c4:6d:8f:58:32:a6:bb:05:90:9d:ec:0f:a9:97:51:
      36:18:dc:da:08:b6:da:20:7d:5f:f5:94:45:55:66:52:9d:17:
      cf:ae:06:64:c7:07:5f:f6:cc:43:53:e6:f7:64:7a:fd:13:e7:
      8c:0d:f1:0f:c3:04:32:1b:92:72:b7:20:1b:00:e6:77:bb:3e:
      3f:92:0c:c4:60:21:d7:1e:95:94:78:d2:20:67:d9:9c:ea:65:
      db:7c:fa:1a:eb:d2:3a:b2:7e:ed:fe:66:05:91:66:56:63:e5:
      52:0d:2b:ad:51:ce:ab:c7:c4:49:35:df:67:c3:2e:c6:75:c6:
      42:e2:1d:50:d5:4e:3f:c9:4f:12:b1:55:c2:f4:09:d6:c2:a7:
      9a:90:75:6e:54:ec:73:94:c5:ff:df:d5:57:50:54:76:c0:70:
      2b:d1:ec:66:20:5a:02:2c:60:1a:bd:55:15:16:c0:08:9c:9e:
      2c:29:c3:cd:5c:77:f3:40:48:a6:e6:8f:10:d3:0c:74:5d:fb:
      06:fb:08:d1:da:0d:2a:ea:91:a7:5f:23:46:8f:b7:57:5b:b1:
      3f:32:2a:84:af:3d:46:d9:7e:94:b6:b7:7a:59:98:8c:6d:fb:
      8e:db:87:08:22:49:35:51:44:94:a9:a6:04:5d:3c:41:fb:e0:
      19:c1:15:02:ba:d5:ac:24:cf:8a:9d:f9:81:ee:b3:ad:e4:21:
      1e:3d:b9:f6:fb:82:04:a7:67:16:e6:42:c8:6a:f5:be:00:2e:
      c2:ae:cd:15:1f:a4:29:5a:6e:b7:16:2f:7b:32:21:8e:39:20:
      10:92:17:e4:27:4f:9b:5f:dc:19:a1:9d:1f:ad:5f:e9:cb:85:
      c1:f6:15:c2:9b:4f:86:56:92:5d:3f:70:9f:c6:41:4b:d5:df:
      d8:24:e1:c4:9b:f0
```

As another example, an X509 certificate that does not include any encryption capability data (e.g., does not include the Extended Key Usage extension or encryption capability data specified in this, or any other, attribute of the certificate) is shown in Appendix B.

```
APPENDIX B
Certificate:
  Data:
    Version: 3 (0x2)
    Serial Number: 1560438257291 (0x16b515e368b)
    Signature Algorithm: sha256WithRSAEncryption
    Issuer: DC = com, DC = zixtest, DC = z061319, OU = msp-zone2-b, O =
        ZixCorp, CN = ZixVPM/5D0265F1
    Validity
        Not Before: Jun 13 15:04:17 2018 GMT
        Not After : Jun 13 15:04:17 2029 GMT
    Subject: DC = com, DC = zixtest, DC = z061319, OU = msp-zone2-b, O =
        ZixCorp, CN = ZixVPM/5D0265F1
    Subject Public Key Info:
        Public Key Algorithm: rsaEncryption
          RSA Public-Key: (3072 bit)
          Modulus:
            00:ab:f4:66:f0:d9:70:b7:38:6e:90:60:4f:80:f2:
            a1:33:8a:13:81:54:6d:d2:e7:77:ab:db:5c:e7:43:
            7e:13:ed:35:8e:1c:21:3d:d9:41:76:e9:31:ab:a7:
            1f:7b:75:19:0a:06:f8:ea:d8:bb:95:f3:a6:8c:b7:
            43:5f:ee:09:57:7f:6c:5e:55:d8:d7:46:d0:91:97:
            dc:50:93:13:43:30:da:61:72:8e:79:32:84:de:0e:
            9b:ff:72:0d:10:11:58:0a:70:34:85:58:b2:26:75:
            c1:dc:68:d6:40:5b:8c:f3:53:00:57:be:b1:a6:a9:
            d6:91:75:f7:80:8c:8a:de:cc:2f:29:f6:58:63:07:
            be:1c:ef:f8:1c:e5:ba:1e:62:f0:f4:3f:9a:5c:ad:
            97:43:c8:df:db:32:c2:12:8e:2f:b9:0d:02:15:df:
            8d:9f:da:6f:da:c1:6c:eb:d5:8c:e5:be:1c:bd:b4:
            a5:94:c8:e8:15:dd:5c:5f:0c:c4:c5:78:5f:0a:c1:
            ae:c8:70:6b:c6:1d:38:05:e0:eb:5a:62:e1:bc:95:
            f2:ee:c0:c5:a9:e5:18:5d:2b:da:22:27:62:96:84:
            e8:92:33:2e:c4:71:d0:5c:44:41:6d:3b:31:06:59:
            5e:02:f3:6c:e4:62:06:91:59:9c:6e:be:95:8c:9b:
            73:f9:a4:da:82:23:e3:75:91:16:f5:1c:9a:62:2c:
            27:2c:39:2b:5f:63:26:b1:7a:90:c1:b3:d0:33:42:
            9b:22:fd:1c:f2:0b:f8:c0:d4:bd:18:db:76:2a:91:
            ea:37:02:c4:fb:21:32:9e:21:54:42:57:db:f3:4a:
            b6:a6:ce:ff:31:2e:2f:77:2c:89:0a:32:7c:cb:fe:
            89:ea:90:76:0b:39:b3:ef:d0:98:c6:4a:be:41:60:
            80:f4:93:e0:6e:c4:c8:92:f7:c3:13:7f:6a:e4:27:
            5b:e1:ce:8f:8b:f7:1c:80:55:68:17:fd:8f:df:48:
            ae:af:47:40:46:cf:46:0b:74:cb
          Exponent: 65537 (0x10001)
    X509v3 extensions:
        X509v3 Subject Alternative Name:
          email:zixvpmgateway@inbound-b.zyyy.example.com
  Signature Algorithm: sha256WithRSAEncryption
      36:54:a5:99:97:1c:ea:ed:b1:b4:6b:19:c6:c3:91:8c:e1:fe:
      d2:24:e9:a8:71:b0:cb:cd:7e:78:9a:40:7a:01:26:b0:6d:44:
      28:e9:60:32:f6:dd:34:31:66:17:21:d0:3a:32:ad:4e:b4:d6:
      87:c4:0f:b1:1c:41:27:65:84:95:79:55:d7:19:1b:d3:02:e0:
      ee:56:d9:2d:01:25:54:85:c1:42:68:4e:06:5a:aa:60:75:b6:
      53:03:21:2d:70:5d:75:01:89:88:42:21:0c:b9:bb:22:02:10:
      50:3a:d8:15:cb:ea:48:30:f4:9c:b7:32:73:7a:90:6c:7f:d9:
      7a:b0:4a:b0:3c:09:f0:01:ba:e3:ea:e3:53:06:4b:d4:72:cd:
      1a:57:4a:07:5d:18:05:1a:2f:20:70:b1:15:3e:5c:0d:4b:e5:
      70:34:88:55:9a:d8:9d:4c:0d:0a:d9:62:f8:e4:10:e9:e3:36:
      c2:69:33:12:05:e8:92:b0:86:03:49:49:50:6e:b6:9d:bc:40:
      d0:bc:4c:dc:43:fd:3c:d8:e7:8d:46:7e:fa:95:09:d9:43:e3:
      f8:36:42:4e:06:dd:81:ff:b5:ed:ce:b5:5a:fb:62:88:cf:66:
      09:bc:db:70:5e:87:db:75:3e:44:67:d7:bf:13:c7:39:98:e2:
      6c:dd:79:b1:bd:bc:1e:73:43:a9:82:39:a7:7e:77:5d:ea:a2:
      fc:8d:9f:33:5a:f4:df:69:1a:6a:7d:78:a6:40:66:95:16:47:
      da:4f:2a:c5:fe:ac:1f:f5:f8:33:d0:47:58:35:cc:c0:51:12:
      45:b9:da:80:7d:08:ae:f7:a8:c8:5e:81:03:f5:eb:23:35:ca:
      30:61:f1:3a:f5:0c:e1:3a:ef:89:6d:da:2d:17:0e:89:38:a8:
      e8:f9:bf:42:0d:57:8f:c8:b0:b9:cf:13:67:a1:19:86:4c:22:
      2d:ed:6a:e2:c7:81:b1:8b:73:4b:33:f1:91:c0:d2:a5:6b:67:
      c8:6e:3a:74:6a:cd
```

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a CPU, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HTML, or any other programming or scripting code, etc. . . . Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums. Data may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. . . . The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines, or portions thereof described herein, where such software programming or code can be stored in a computer-readable medium and can be operated on by a processor to permit a computer to perform any of the steps, operations, methods, routines, or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, HDs, data cartridges, magnetic tapes, floppy diskettes, flash memory drives, optical data storage devices, CD-ROMs, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals, or other information. A processor can include a system with a general-purpose CPU, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, that follow, a term preceded by “a set”, “a” or “an” (and “the” when antecedent basis is “a” or “an”) includes both singular and plural of such term, unless clearly indicated otherwise (i.e., that the reference “a set”, “a” or “an” clearly indicates only the singular or only the plural). Also, as used in the description herein the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

What is claimed is:

1. A method performed by a sending messaging gateway, the method comprising:
obtaining, by the sending messaging gateway, a public certificate associated with a recipient messaging gateway;
determining, by the sending messaging gateway based on evaluating the public certificate, whether the public certificate contains a predefined capability indicator signifying support, by the recipient messaging gateway, for an enhanced encryption scheme;
responsive to determining that the public certificate contains the predefined capability indicator, selecting, by the sending messaging gateway, the enhanced encryption scheme;
responsive to determining that the public certificate does not contain the predefined capability indicator, selecting, by the sending messaging gateway, a legacy encryption scheme;
encrypting, by the sending messaging gateway, a message using the selected encryption scheme to generate an encrypted message; and
transmitting, by the sending messaging gateway, the encrypted message to the recipient messaging gateway.

2. The method of claim 1, wherein obtaining the public certificate comprises retrieving the public certificate from a local certificate cache maintained by the sending messaging gateway, wherein the local certificate cache is synchronized with a central certificate repository storing public certificates for a plurality of messaging gateways, wherein a messaging gateway comprises the recipient messaging gateway.

3. The method of claim 1, wherein the public certificate is an X.509 certificate, wherein the predefined capability indicator is located within an extensions section of the X.509 certificate.

4. The method of claim 3, wherein the predefined capability indicator comprises a specific bit within a Key Usage extension being set to a predefined value.

5. The method of claim 3, wherein the predefined capability indicator comprises the presence of a predefined Object Identifier (OID) within one of: a custom extension or a Certificate Policies extension.

6. The method of claim 1, wherein the enhanced encryption scheme comprises using Advanced Encryption Standard (AES) in Galois/Counter Mode (GCM) for content encryption and Rivest-Shamir-Adleman (RSA) encryption with Optimal Asymmetric Encryption Padding (OAEP) for key encryption.

7. The method of claim 1, wherein the legacy encryption scheme comprises using Advanced Encryption Standard (AES) in Cipher Block Chaining (CBC) mode for content encryption and Rivest-Shamir-Adleman (RSA) encryption with Public-Key Cryptography Standards (PKCS) #1 v1.5 padding for key encryption.

8. A sending messaging gateway system, comprising:
a network interface configured to communicate over a network;
one or more processors; and
a memory storing instructions that, when executed by the one or more processors, cause the system to perform operations comprising:
obtaining, via the network interface, a public certificate associated with a recipient messaging gateway;
determining, based on evaluating the public certificate, whether the public certificate contains a predefined capability indicator signifying support for an enhanced encryption scheme at the recipient messaging gateway;
responsive to determining that the public certificate contains the predefined capability indicator, selecting the enhanced encryption scheme;
responsive to determining that the public certificate does not contain the predefined capability indicator, selecting a legacy encryption scheme;
encrypting a message using the selected encryption scheme to generate an encrypted message; and
transmitting, via the network interface, the encrypted message to the recipient messaging gateway.

9. The system of claim 8, wherein obtaining the public certificate comprises retrieving the public certificate from a local certificate cache maintained by the sending messaging gateway, wherein the local certificate cache is synchronized with a central certificate repository storing public certificates for a plurality of messaging gateways, wherein a messaging gateway comprises the recipient messaging gateway.

10. The system of claim 8, wherein the public certificate is an X.509 certificate, wherein the predefined capability indicator is located within an extensions section of the X.509 certificate.

11. The system of claim 10, wherein the predefined capability indicator comprises a specific bit within a Key Usage extension being set to a predefined value.

12. The system of claim 10, wherein the predefined capability indicator comprises the presence of a predefined Object Identifier (OID) within one of: a custom extension or a Certificate Policies extension.

13. The system of claim 8, wherein the enhanced encryption scheme comprises using Advanced Encryption Standard (AES) in Galois/Counter Mode (GCM) for content encryption and Rivest-Shamir-Adleman (RSA) encryption with Optimal Asymmetric Encryption Padding (OAEP) for key encryption.

14. The system of claim 8, wherein the legacy encryption scheme comprises using Advanced Encryption Standard (AES) in Cipher Block Chaining (CBC) mode for content encryption and Rivest-Shamir-Adleman (RSA) encryption with Public-Key Cryptography Standards (PKCS) #1v1.5 padding for key encryption.

15. A non-transitory computer-readable medium storing instructions that, when executed by one or more processors of a sending messaging gateway, cause the sending messaging gateway to perform operations comprising:
obtaining a public certificate associated with a recipient messaging gateway;
determining, based on evaluating the public certificate, whether the public certificate contains a predefined capability indicator signifying support, by the recipient messaging gateway, for an enhanced encryption scheme;
responsive to determining that the public certificate contains the predefined capability indicator, selecting the enhanced encryption scheme;
responsive to determining that the public certificate does not contain the predefined capability indicator, selecting a legacy encryption scheme;
encrypting a message using the selected encryption scheme to generate an encrypted message; and
transmitting the encrypted message to the recipient messaging gateway.

16. The non-transitory computer-readable medium of claim 15, wherein obtaining the public certificate comprises retrieving the public certificate from a local certificate cache maintained by the sending messaging gateway, wherein the local certificate cache is synchronized with a central certificate repository storing public certificates for a plurality of messaging gateways, wherein a messaging gateway comprises the recipient messaging gateway.

17. The non-transitory computer-readable medium of claim 15, wherein the public certificate is an X.509 certificate, wherein the predefined capability indicator is located within an extensions section of the X.509 certificate.

18. The non-transitory computer-readable medium of claim 17, wherein the predefined capability indicator comprises the presence of a predefined Object Identifier (OID) within one of:
a custom extension or a Certificate Policies extension.

19. The non-transitory computer-readable medium of claim 15, wherein the enhanced encryption scheme comprises using Advanced Encryption Standard (AES) in Galois/Counter Mode (GCM) for content encryption and Rivest-Shamir-Adleman (RSA) encryption with Optimal Asymmetric Encryption Padding (OAEP) for key encryption.

20. The non-transitory computer-readable medium of claim 15, wherein the legacy encryption scheme comprises using Advanced Encryption Standard (AES) in Cipher Block Chaining (CBC) mode for content encryption and Rivest-Shamir-Adleman (RSA) encryption with Public-Key Cryptography Standards (PKCS) #1 v1.5 padding for key encryption.
